(19) United States
(12) Patent Application Publication
(10) Pub. No.: US 2022/0260095 A1
(43) Pub. Date: Aug. 18, 2022

(54) VALVE BLOCK, SECURING ELEMENT, VALVE UNIT, METHOD FOR PRODUCING A VALVE BLOCK, AND METHOD FOR PRODUCING A SECURING ELEMENT

(71) Applicant: ARGO-HYTOS Group AG, Baar (CH)

(72) Inventors: Klaus Mössinger, Obersulm (DE); Valentin Pichlmaier, Bretten (DE); Daniel Trunner, Kraichtal (DE); Tobias Wendel, Bad Schönborn (DE); Thomas Weiser, Sinsheim (DE)

(21) Appl. No.: 17/625,684

(22) PCT Filed: Jul. 1, 2020
(86) PCT No.: PCT/EP2020/068531

§ 371 Date: Jan. 7, 2022

(30) Foreign Application Priority Data
Jul. 9, 2019 (DE) 10 2019 118 495.9

(51) Int. Cl. F15B 13/02; F16K 27/00

(52) U.S. Cl. CPC F15B 13/021; F15B 2013/004; F16K 27/003

(57) ABSTRACT

The present invention relates to a valve block, for at least one valve, in particular a slip-in valve having at least one cavity for receiving the valve; a first opening for inlet of a fluid and a second opening for outlet of the fluid, wherein the openings open into the cavity; a mounting area in which the openings are provided; and a collar for securing the valve, which collar extends at least in sections around the cavity, wherein the collar integrally formed with the valve block by primary shaping, in particular injection molding or die casting.

The invention relates to a valve block, a retaining element, a valve unit, a method for manufacturing a valve block and a method for manufacturing a retaining element.

In general, valve units are used to control and regulate fluid flows in a fluid system. Essentially, the valve units each comprise a valve and a valve block in which the valves are arranged. The valves are often used in the form of directional valves, flow divider valves, pressure valves, lowering brake valves, throttle valves or proportional valves. The valves can be configured as screw-in valves or plug-in valves (slip-in valves), for example.

It is generally known that the valve block of the valve unit is to be designed depending on the system pressure of the fluid system. Normally, valve blocks made of plastics are used in low-pressure systems and valve blocks made of metal are used in high-pressure systems. The disadvantage here is that high mechanical processing efforts are required to manufacture the valve block, as a result of which costs are significantly increased. In particular, the valve blocks are often mechanically reworked to achieve the required manufacturing accuracies.

It is an object of the invention to provide a valve block that can be manufactured in a simple and cost effective manner and is light in weight. It is a further object of the invention to provide a retaining element, a valve unit, a method for manufacturing the valve block and a method for manufacturing the retaining element.

According to the invention, this object is achieved with regard to the valve block by the subject matter of claim 1. With regard to the retaining ring, the valve unit and the methods, the aforementioned object is achieved by the subject matter of claim 11 (retaining element), claim 21 (valve unit), claim 22 (method for manufacturing the valve block) and claim 24 (method for manufacturing the retaining element), respectively.

The invention is based on the idea of providing a valve block for at least one valve, in particular a slip-in valve, comprising:
at least one cavity for receiving the valve;
at least two openings for the inlet and/or outlet of a fluid, wherein the openings open into the cavity;
at least one mounting area in which the at least two openings are provided; and
at least one collar for securing the valve, which collar extends at least in sections around the cavity, wherein

the collar is integrally formed with the valve block by primary shaping, in particular injection molding or die casting.

The invention has several advantages. Advantageously, due to the cavity, a valve or slip-in valve can be received. Together with the valve, the cavity enables one or more fluid flows to be controlled or regulated. During operation, the fluid enters the valve and/or the cavity through the two openings provided in the mounting area and opening into the cavity. The valve can control the flow direction of the fluid and/or regulate the pressure or flow of the fluid. Additionally or alternatively, the valve can divide the fluid flow. The valve block can be fluidly connected to a fluid system, in particular a piping system, via the mounting area. By arranging the openings in the mounting area it is advantageously possible to connect the valve block to a fluid system and secure it in one step. Furthermore, this integral design of the mounting area supports a compact design of the valve block.

The invention has the further advantage that due to the collar, the valve can be easily and quickly secured or mounted to the valve block. During mounting, the valve is pushed with a control portion for controlling and/or regulating the fluid into the cavity. In the axial final mounting position, the valve rests against the collar of the valve block and is held or fixed in this position. A separate retaining element can be used for this purpose.

The valve block is formed as a single piece by primary shaping. The collar is integrally formed with the valve block by primary shaping, in particular injection molding or die casting. In other words, the collar and the valve block are made in one piece by primary shaping. This has the advantage that the valve block and the collar can be produced in a simple and cost effective manner Preferably, the collar and the valve block are manufactured in a single injection molding step or die casting step. Furthermore, by forming the valve block by means of primary shaping, complex designs are possible, which increases the number of variants of the valve block. Furthermore, as a result, the valve block can be manufactured with a minimum of effort and optimized in weight, so that material is saved and thus costs can be reduced. By means of primary shaping, the valve block can be manufactured in large quantities, thereby keeping costs low.

The valve block can be formed in one piece by casting. The valve block can be designed as a plastic injection-molded part or as an aluminum die-cast part. The valve block can be formed from a thermoplastic material. The valve block can be formed by 3D printing from one piece. In other words, it is conceivable that the valve block is designed as a 3D printed part.

In a manufacturing process according to the invention, a valve block is formed in one piece by at least one primary shaping method. The valve block can be formed in one piece by casting. The valve block can be formed in one piece by injection molding or die casting. Here, the valve block comprises at least one cavity for receiving a valve, in particular a slip-in valve, and at least two openings for the inlet and/or outlet of a fluid. The openings open into the cavity. In addition, the valve block comprises at least one collar for securing the valve, which collar extends at least in sections around the cavity. Furthermore, the valve block has a mounting area in which the at least two openings are provided. In this connection, the cavity, the openings, the collar and the mounting area are manufactured together with the valve block by the primary shaping process, in particular by injection molding or die casting.

It is conceivable that the collar for securing the valve and/or the cavity and/or the mounting area are/is formed exclusively by at least one primary shaping process. In other words, the collar and/or the cavity and/or the mounting area are produced by the primary shaping process without requiring any rework. This eliminates the need for subsequent machining of the valve block, thereby reducing manufacturing costs.

Preferred embodiments of the invention are specified in the subclaims.

In a preferred embodiment, the cavity is formed by a blind hole into which the valve can be inserted for mounting. In other words, the cavity is formed by a substantially hollow cylindrical recess. In the mounted state, the valve can protrude to just before the axial end of the blind hole, forming a separate fluid space in this region. One of the two openings for the inlet or outlet of the fluid can open into the fluid space. The blind hole has the advantage that the axial end of the cavity is closed by the shape of the blind hole, thus eliminating the need for additional sealing of the cavity.

In another preferred design, the cavity is formed to be stepped for engaging at least two, in particular a plurality of sealing elements of the valve. In other words, the cavity has at least one step which tapers the cavity inwards. The cavity can be formed in a rotationally symmetrical manner Preferably, the cavity has a plurality of steps. The cavity can have at least one conical portion between the steps. In other words, the cavity can taper inward. The tapered portion can form a draft which is formed before and/or after the step. The draft serves to remove a core of at least one primary shaping tool from the cavity after a primary shaping process, in particular injection molding or die casting processes. Depending on the material, the draft can be between 0.5° and 3°. It is conceivable that the cavity is unmachined after forming by primary shaping. Due to the stepped design, several sealing connections can be implemented successively, in particular by means of sealing elements, between the valve and the valve block in the axial direction of the cavity, so that the openings for the fluid inlet or outlet are sealed against each other. As a result, a reliable function of the valve is achieved.

The cavity can have at least two sealing surfaces for sealing against the valve. The sealing surfaces can be arranged in at least one of the conical portions of the cavity. In the mounted state, the sealing surfaces interact with at least one sealing element of the valve so that the openings for the fluid are sealed against each other. Further, at least one of the sealing surfaces can interact with a sealing element of the valve to seal the cavity in a fluid-tight manner towards an open end. The sealing surfaces thus advantageously allow the openings to be sealed with respect to each other and the cavity to be sealed towards the open end.

Preferably, the collar is formed at a first axial end of the cavity where the cavity is open to the outside for insertion of the valve. The collar for securing or holding the valve is preferably located outside the cavity. It is of advantage here that the valve rests against the collar of the valve block during mounting. This axial position of the valve corresponds to the axial mounting end position. The valve can therefore be exactly positioned in the axial direction in a quick and simple manner by the collar of the valve block.

Furthermore, the collar on the valve block is preferably formed to extend radially around the cavity. The collar can extend radially outwards from the cavity. The collar can be integrally formed with the valve block exclusively by primary shaping, in particular injection molding or die casting. The collar may be unmachined, in particular mechanically unmachined. In other words, the collar may not be reworked.

The valve block can be connected to the valve through the collar by means of a retaining element. When mounting the valve, the retaining element is slid over the collar of the valve block so that the retaining element is positively connected to the collar. Subsequently, the valve is at least partially inserted into the cavity in such a manner that a mating contour of the valve engages with the retaining element, in particular snaps into place. Preferably, the collar has a contact surface on the front side, against which the valve rests during mounting. Specifically, after mounting, in particular in the mounting end position, the valve can rest with its mating contour against the front contact surface of the collar of the valve block. Thus, the collar advantageously allows the valve to be quickly and easily connected to the valve block.

In another preferred embodiment, the valve block has at least one extension which is formed radially outwards and axially spaced apart from the collar. The extension can project radially beyond the collar. The extension can be integrally formed with the valve block exclusively by primary shaping, in particular injection molding or die casting. The extension may be unmachined, in particular mechanically unmachined. The extension can form an axial stop for the retaining element for securing or holding the valve. The extension may be spaced apart from the collar such that a groove between the extension and the collar is formed. The groove may be formed to extend circumferentially. The advantage of the extension is that when mounting the valve, the retaining element is positioned axially in a simple manner. The extension thus facilitates mounting, thereby saving time and costs.

Preferably, the valve block has a plurality of ribs which are grid-shaped. This has the advantage that the valve block has high stability with low component weight.

In a preferred embodiment, the valve block has at least one positive-locking means through which the valve block can be connected to other valve blocks in a positive-locking manner. In other words, the positive-locking means can be used to create an arrangement of a plurality of valve blocks which are connected to each other in a positive-locking manner. The valve block preferably has at least one first positive-locking means and at least one second positive locking means. The first positive-locking means can be formed protruding from the valve block and the second positive-locking means can be formed as a recess in the valve block. The advantage here is that the valve block can be easily connected to other valve blocks to form an arrangement having a compact design. Due to its modularity, the valve block is easy to handle, which facilitates mounting, in particular of a plurality of valve blocks.

The positive-locking means can be V-shaped, in particular dovetail-shaped. This has the advantage that through the positive-locking connection of, e.g., two valve blocks, they can be kept in at least one plane. The valve blocks therefore advantageously have a defined position in relation to each other, which facilitates mounting.

In a preferred embodiment, the mounting area is arranged on an underside of the valve block and can be connected to at least one flange connection, in particular of a fluid system. The mounting area is preferably fluidly connected to the cavity through the openings for the fluid. The mounting area can be integrally formed with the valve block exclusively by primary shaping, in particular by injection molding or die casting. In other words, the mounting area can be unmachined, in particular mechanically unmachined. The mounting area can have at least one mounting surface against which the flange connection rests in the mounted state. Through the mounting area, the valve block can be advantageously in fluid communication with a fluid system, in particular a hydraulic system.

A secondary aspect of the invention relates to a retaining element used to attach a first component to a second component. The retaining element has an annular body that is formed to be open radially outwards. In other words, the annular body is C-shaped. The annular body further has at least one extension extending radially inward. The extension is in each case attached to an axial end of said body, the extensions being axially spaced apart from each other such that a space is formed between the extensions for receiving the components. The projections have at least one contact surface, in particular a holding surface, for the components, which is formed axially inside.

The open design of the ring-shaped body has the advantage that the retaining element can be expanded, in particular spread apart, for the mounting or dismantling of the components. This facilitates handling of the retaining element during mounting or dismantling. The extensions, which extend radially inwards, have the advantage that in the mounted state, the components are held axially by the extensions. In contrast to the retaining element according to EP 1 653 141 B1, the arrangement of the extensions at the axial ends allows for achieving a particularly compact design in the axial direction, which saves installation space.

During operation, for example, when forming the first component as a slip-in valve and the second component as a valve block, a fluid force is applied to the slip-in valve in such a manner that it presses the slip-in valve out of the valve block. At the same time, the retaining element prevents the slip-in valve from being pushed out axially, since the extensions axially fix or hold the slip-in valve on the valve block. Advantageously, the extensions have a contact surface or holding surface against which the components can rest for axial fixation. In other words, the extensions for axial fixation of the components can form at least one stop.

The retaining element serves, for example, for securing a valve, in particular a slip-in valve, to a valve block. Alternatively, the retaining element serves to secure a fluid line, in particular a hydraulic line, e.g. to a container, in particular a hydraulic tank. The retaining element advantageously fixes the first component on the second component in a secure manner.

In a preferred embodiment of the retaining element, the annular body is elastically deformable for mounting and/or dismantling. In other words, the annular body is expandable so that the retaining element can be brought into positive engagement with the components. This results advantageously in that connecting the two components is significantly simplified. The retaining element can be handled in an advantageously quick and simple manner. This reduces mounting time and saves costs.

Preferably, a plurality of extensions is in each case arranged at the axial ends, the extensions being evenly distributed in the circumferential direction. The projections can be spaced apart from each other in the circumferential direction. The advantage here is that the contact surfaces of the individual extensions form a common, in particular large-scale, contact surface. In the mounted state, an axial force, in particular an axial extension force, is thus uniformly introduced into the securing element by at least one of the components. Furthermore, this results in an improved stress distribution in the securing element and thus the service life of the retaining element is increased. Therefore, reliability of the retaining element is significantly increased.

More preferably, at least one transition between the extensions and the annular body is formed according to the method of tensile triangles. Preferably, at least one first transition is formed in the circumferential direction between the individual projections and the annular body and/or at least one second transition is formed between the individual projections and the annular body towards the space. By means of the formation of the respective transition according to the method of tensile triangles, stress occurring during operation and/or mounting, in particular tensile stress, is homogeneously distributed in the transition. In other words, stress occurring locally in the transition is minimized by forming the transition from several, in particular three, tensile triangles. This advantageously results in enabling an increased number of load changes of the extensions, in particular elastic deformations, and in achieving an increased service life of the retaining element.

In general, the tensile triangle method combines several, in particular three, tensile triangles. The tensile triangles are designed as isosceles triangles. A first tensile triangle can substantially form a right-angled triangle. The two legs of a second tensile triangle correspond to the length of half the hypotenuse of the first tensile triangle, the hypotenuse of the second tensile triangle extending from half of the length, in particular the middle, of the hypotenuse of the first tensile triangle. Furthermore, the two legs of a third tensile triangle correspond to the length of half the hypotenuse of the second tensile triangle, the hypotenuse of the third tensile triangle extending from half the length, in particular the middle, of the hypotenuse of the second tensile triangle. The transitions have a longitudinal side and a broad side, the longitudinal side being formed in the direction of the tensile force. Through such an arrangement of the tension triangles, stress in the region of transition is reduced and thus the service life of the securing element is increased.

In a preferred embodiment, the extensions are each trapezoidal in cross-section. In other words, the projections taper radially inwards in cross-section starting from the annular body. As a result, sliding the retaining element onto one and/or both components is advantageously simplified.

In another preferred embodiment, the extensions have a modulus of resistance that increases radially from the inside to the outside towards the annular body. This has the advantage that stress distribution is improved and the failure force of the retaining element is increased. As a result, secure fixation of the component can be advantageously achieved.

In another preferred embodiment, the extensions at both axial ends of the annular body each form at least one insertion chamfer for the components, which runs axially inwards. In other words, the insertion chamfer is oriented towards the space. As a result, sliding the retaining element onto one and/or both components is advantageously simplified. In general, this advantageously simplifies mounting thereby saving costs.

In a particularly preferred embodiment, the annular body has at least two receiving elements for at least one mounting means for demolding and/or dismantling, in particular for elastically deforming, the retaining element. The mounting means can be formed by a pair of pliers. The receiving elements can each form a nose. For removing or dismantling, the mounting means can engage with the respective nose, in particular interact therewith. When demolding or dismantling, the mounting means interacts with the receiving elements in such a manner that the retaining element is expanded or spread apart. Therefore, the retaining element can be connected to the components in an advantageously quick and simple manner More specifically, the valve can be mounted or fixed to the valve block in a quick and simple manner.

Preferably, the annular body has a multiplicity of ribs extending radially outwards. The ribs connect in each case two axially opposite extensions to increase a holding force. In other words, the ribs protrude radially outwards beyond the annular body. If an increased force acts on the extensions during operation and/or mounting or dismantling, the ribs support the extensions in the axial direction. This advantageously increases the stability of the extensions and thus of the retaining element.

More preferably, the ribs are evenly distributed in the circumferential direction, so that stress occurring during elastic expansion, in particular during mounting or dismantling, is homogeneously distributed in the retaining element. This has the advantage that the retaining element can be opened much further during elastic deformation or during mounting or dismantling than a retaining element having a constant cross-section of the annular body. In other words, this considerably facilitates mounting or dismantling the retaining element and thus the components.

Another secondary aspect of the invention relates to a valve unit having at least one valve, in particular a directional valve, a valve block according to the invention and a retaining element according to the invention. The valve and the valve block each have at least one contour, in particular a collar, for securing. Furthermore, the valve and the valve block engage with respective contours in the retaining element so that the retaining element interacts with the contours and connects the valve and the valve block to one another.

When mounting the valve on the valve block, the retaining element is slid over the contour, in particular the collar, of the valve block so that the retaining element is positively connected to the contour. The contour or collar engages with the retaining element. Subsequently, the valve is at least partially inserted into the valve block until the contour or collar of the valve engages with the retaining element. The valve is slid with the contour into the retaining element so that it engages with the retaining element. The retaining element fixes the valve to the valve block in such a manner that the valve is prevented from sliding axially out of the valve block. It is of advantage here that the valve can be mounted manually in a quick and simple manner without any additional tools. As a result, manufacturing costs and, in particular, mounting costs are saved.

In a method according to the invention for manufacturing a retaining element, an annular body is formed in one piece by at least one injection molding process. The annular body is formed to be open radially outwards and has a multiplicity of extensions which extend radially inwards. The extensions are each arranged at an axial end of the body and axially spaced apart from each other in such a way that a space is formed between the extensions to receive the components.

In a preferred embodiment of the manufacturing method according to the invention, the annular body is arranged positively on a core of an injection molding tool by means the injection molding process.

In another preferred embodiment of the manufacturing method according to the invention, the annular body is removed from the core of the injection mold by elastically deforming it, in particular by spreading it apart. In this embodiment it is of advantage that a collapsible core for removing the retaining element can be omitted. As a result, manufacturing costs are significantly reduced.

Preferably, the annular body is elastically deformed, in particular spread apart, for removal by at least one removal tool, in particular a puller collet.

With regard to the further advantages of the methods for manufacturing a valve block according to the invention and a retaining element according to the invention, reference is made to the advantages explained in connection with the valve block and the retaining element. Moreover, the methods may alternatively or additionally include individual features or a combination of several previously mentioned features with respect to the valve block and the retaining element.

The invention will be explained in more detail below with reference to the attached drawings. The embodiments shown are examples of how the valve block according to the invention and the retaining element can be configured.

In the Figures:

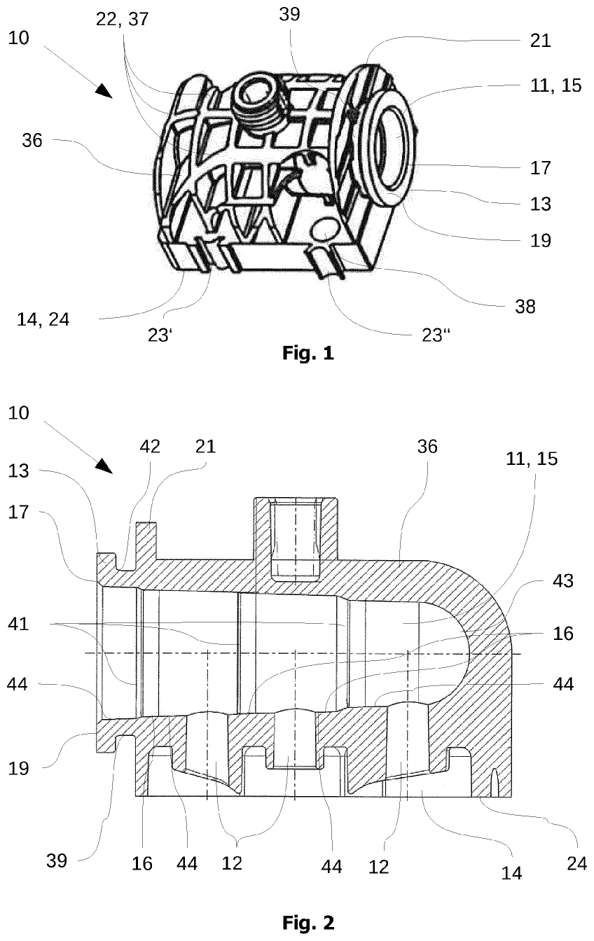

FIG. 1 shows a perspective view of a valve block according to an exemplary embodiment according to the invention;

FIG. 2 shows a longitudinal sectional view of the valve block according to FIG. 1;

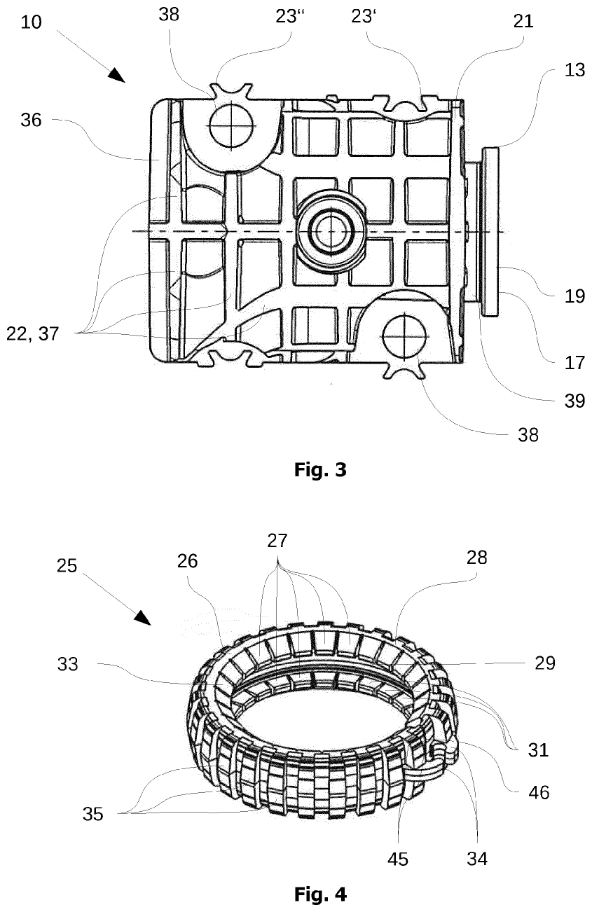

FIG. 3 shows a top view of the valve block according to FIG. 1;

FIG. 4 shows a perspective view of a retaining element according to an exemplary embodiment according to the invention;

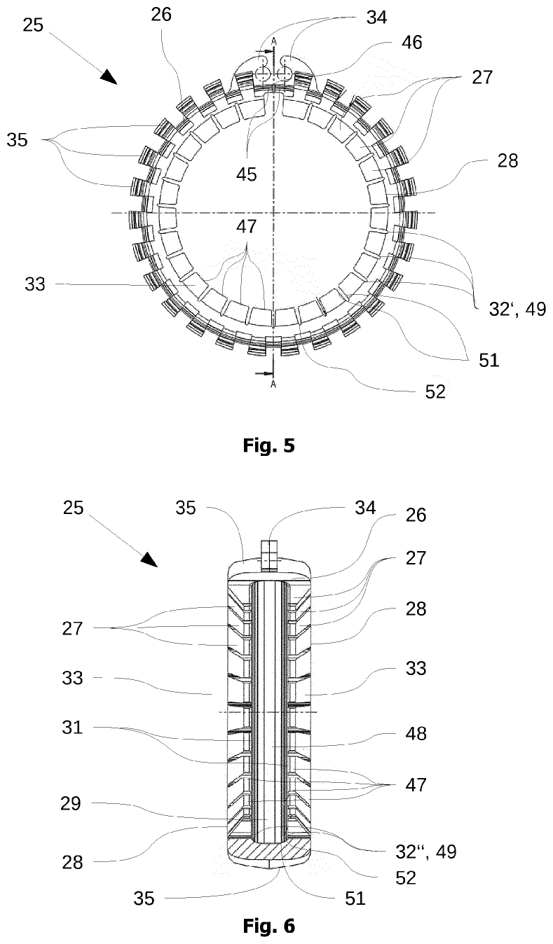

FIG. 5 shows a top view of the retaining element according to FIG. 4;

FIG. 6 shows a longitudinal sectional view of the retaining element according to FIG. 4; and

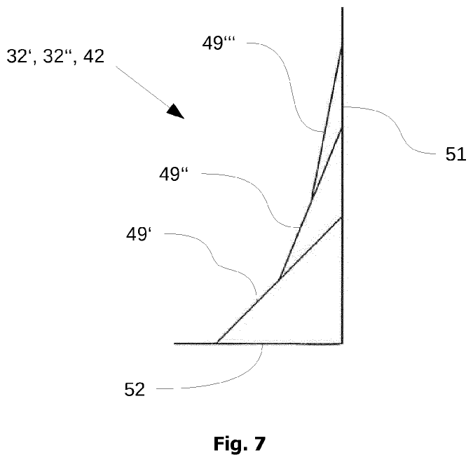

FIG. 7 shows a schematic sectional view of a transition according to FIGS. 1 to 6.

FIG. 1 to FIG. 3 show a valve block 10 for a valve, in particular a slip-in valve, according to a preferred exemplary embodiment according to the invention. The valve block 10 is formed in one piece by primary shaping, in particular injection molding or die casting. The valve block 10 can be formed from one piece by casting. The valve block can be formed by an injection-molded plastic part or an aluminum die cast part.

The valve block 10 comprises a cavity 11 for receiving a valve, three openings 12 for the inlet and/or outlet of a fluid, a collar 13 for securing the valve and an mounting area 14 for securing the valve block 10 to a connection of a fluid system, in particular a hydraulic system. The fluid may be hydraulic oil. Alternatively, the fluid can also be a different fluid or gas.

According to FIG. 1, the mounting area 14 of valve block 10 is plate-shaped. The valve block 14 has a base body 36 which is arranged on the mounting area 14. The base body 36 has cavity 11, which is formed in the main body 26 in the longitudinal direction. The base body 36 has a grid-shaped reinforcing structure 37, which is formed by a multiplicity of ribs 22. The base body 36 is integrally formed with the mounting area 14 by primary shaping.

Further, the mounting area 14 has two through holes 38 to connect the valve block 10 to the connection of a fluid system, which is not shown. The through holes 38 can also be used for mounting on a solid body. In the area of the through holes 38, the base body 36 has a material recess so that the through holes 38 are freely accessible.

According to FIG. 3 it is shown that the mounting area 14 comprises a total of four positive-locking means 23, wherein two first positive-locking means 23′ are in each case formed by a recess and two second positive-locking means 23″ are in each case formed by a recess. The positive-locking means 23 are each V-shaped. The valve block 10 can be positively connected 10 to further valve blocks by the positive-locking means 23.

As shown in FIG. 1, collar 13 is formed for securing a valve, not shown, to an extension 21. The extension 21 is formed on the front side of the valve block 10. The extension 21 is formed radially outwards extending from the cavity 11. The collar 13 is formed at a first axial end 17 of the cavity 11. The cavity 11 is formed to be open to the outside at the first axial end 17 for inserting or mounting the valve in the longitudinal direction. The collar 13 extends around the cavity 11. The collar 13 is arranged outside the cavity 11.

The collar 13 is integrally formed with the valve block 10 exclusively by primary shaping, in particular injection molding or die casting. In other words, the collar 13 is mechanically unmachined after being formed by primary shaping. The collar 13 is therefore not subjected to any subsequent machining.

As shown in FIGS. 1 to 3, the collar 13 extends radially around the cavity 11. Starting from the cavity 11, the collar 13 extends radially outwards. The collar 13 is spaced apart from the extension 21. Specifically, a circumferential groove 39 is formed between the extension 21 and the collar 13. The width of the circumferential groove 39 defines the distance between the extension 21 and the collar 13. The collar 13 has a contact surface 19 at the front side against which the valve rests during mounting. During operation, the valve can be spaced apart from the contact surface 19. The distance between the valve and the contact surface 19 can be very small. The collar 13 and the circumferential groove 39 are integrally formed with the valve block 10 exclusively by primary shaping, in particular injection molding or die casting.

A transition 42 is formed between the collar 13 and the circumferential groove 39. The transition 42 is designed according to the method of tensile triangles, which will be discussed later in FIG. 7. Due to the transition 42, the collar 13 shows an increased failure force. In other words, due to the transition 42, the collar 13 can better introduce the tensile forces occurring in the groove 39 or the basic body 36 of the valve block 10. This improves the distribution of local tensile stresses and thus increases the service life.

According to FIG. 2, the cavity 11 is formed by a blind hole 15 into which the valve can be inserted for mounting. The cavity 11 has a total of three steps 41 which taper the cavity 11 towards a second axial end 43. The steps 41 are formed as chamfers, each of which taper the cavity 11 towards the second axial end 43. Also, each of the steps 41 can be formed as a curve, tapering the cavity 11 towards the second axial end 43. The cavity 11 is formed to be rotationally symmetrical.

Furthermore, the cavity 11 has several conical sections 44. The conical sections 44 each form a draft. The draft serves to remove or demold a core of at least one primary shaping tool from the cavity 11 after a primary shaping process, in particular injection molding or die casting process. Depending on the material of the valve block 10, the draft can be between 0.5° and 3°. It is conceivable that the cavity 11 is unmachined after forming by primary shaping.

According to FIG. 2, two of the conical sections 44 are formed between the three steps 41. In the two conical sections 44, at least one sealing surface 16 is provided to seal the valve block 10 against the valve in the mounted state. By means of the steps 41, a plurality of tight connections of the valve with respect to the valve block 10 can be implemented in the longitudinal direction of the cavity 11.

The valve block 10 comprises three openings 12 for the inlet and/or outlet of the fluid. As shown in FIG. 2, openings 12 are provided in the mounting area 14. The openings 12 extend through the mounting area 14 and lead into the cavity 11. In other words, the openings 12 each form a free passage from an underside 24 of the valve block 10 into the cavity 11. Thus, the underside 24 of the valve block 10 is fluidly connected to the cavity 11 through the openings 12. The underside 24 can be connected to at least one flange connection of a fluid system, in particular a fluid component, which is not shown. During operation, the fluid enters the cavity 11 and/or the valve (not shown) inserted into the cavity 11 through the openings 12, and/or the fluid exits the cavity 11 and/or the valve inserted into the cavity 11 through the openings 12.

According to FIGS. 4 to 6, a retaining element 25 for securing a first component to a second component according to a preferred exemplary embodiment according to the invention is shown. The first component can be a valve and the second component can be a valve block. Alternatively, the first component can be a connection of a fluid line and the second component can be a connection of a tank, in particular a hydraulic tank. The aforementioned components are examples only and thus are not limited thereto.

As shown in FIGS. 4 and 5, the retaining element 25 has an annular body 26 which is formed to be open radially outwards. In other words, the annular body 26 is formed to be slotted so that the annular body 26 has a C-shape. Specifically, the annular body 26 comprises two ring ends 45 that are spaced apart from each other. Between the ring ends 45, a slot 46 is formed through which the annular body 26 is open radially outwards. The annular body 26 is elastically deformable for mounting and/or dismantling and/or demolding.

Furthermore, the annular body 26 has a multiplicity of extensions 27 extending radially inward. Together, the extensions 27 define, with a radially inner head side 47, a through hole formed in the longitudinal direction. The extensions 27 have the same length radially inwards. It is also conceivable that at least one individual extension is longer or shorter than the extensions 27. The extensions 27 are formed to be evenly distributed in the circumferential direction. Specifically, the extensions 27 are formed on the inner circumference of the ring-shaped body 26 and are evenly distributed in the circumferential direction. The extensions 27 are spaced apart from each other in the circumferential direction.

As shown in FIG. 5, starting from the ring ends 45, in each case two transitions 32′ are formed in the circumferential direction between the extensions 27. The respective transition 32′ is provided between the individual extension 27 and the annular body 26. The transitions 32′ are formed according to the method of tensile triangles, which will be discussed later with reference to FIG. 7. The transitions 32′ are formed such that a longitudinal side 51 of the respective transition 32′ extends along the extension 27 towards the through hole.

According to FIGS. 4 and 6, the projections 27 are each arranged at an axial end 28 of the body 26 and are axially spaced apart from each other such that a space 29 is formed between the projections 27 to receive the components. Specifically, the axial space 29 between the extensions 27 is formed such that the components can be received. The extensions 27 each have a contact surface 31, in particular a holding surface, for the components, which is formed axially inside. In other words, the contact surfaces 31 on the extensions 27 face the space 29. The space 29 is radially bounded by an inner circumferential surface 48 of the annular body 26 and axially bounded on both sides by the contact surfaces 31 of the extensions 27. A further transition 32″ is formed according to the method of tensile triangles between the contact surface 31 of the inner circumferential surface 48 in order to better introduce the tensile forces occurring during mounting and dismantling as well as during operation into the annular body 26. The longitudinal side 51 of the transition 32″ extends axially along the inner circumferential surface 48 towards the space 29.

The extensions 27 are each trapezoidal in cross-section. Specifically, the extensions 27 have a modulus of resistance which increases from the head side 47 of extensions 27 towards the annular body 26. Thus, stress distribution is improved and failure force of the extensions 27 is increased.

As can be clearly seen in FIG. 6, the extensions 27 are formed at both axial ends 28 of the annular body 26. The extensions 27 each form an insertion chamfer 33 at both axial ends 28 for the components, which runs inward in the axial direction. The insertion chamfer 33 is oriented towards the space 29. Due to the insertion chamfer 33, the components can be easily and quickly connected to each other with the retaining element 25.

The retaining element 25 further comprises two receiving elements 34 for at least one mounting means, which is not illustrated. The receiving elements 34 are formed in the area of the ring ends 45. The receiving elements 34 are substantially hook-shaped. The receiving elements 34 form noses which face each other in the area of the ring ends 45. The receiving elements 34 serve to receive the mounting means, in particular the removal tool, in order to elastically deform the retaining element 25 for demolding during manufacture or for dismantling. In the process of this, the retaining element 25 is spread apart in opposite circumferential directions. The retaining element 25 can be spread apart during a manufacturing step by means of the mounting means so that the retaining element 25 can be demolded or removed from a core of an injection mold.

The annular body 26 further has a multiplicity of ribs 35 extending radially outward. The ribs 35 connect in each case two axially opposite extensions 27 so as to increase a holding force. In other words, the ribs 35 project radially outwards beyond the annular body 26. If an increased force is applied to the extensions 27 during operation and/or mounting or dismantling, the ribs 35 support the extensions 27 in the axial direction.

The ribs 35 are arranged evenly distributed in the circumferential direction on the outer circumference of the annular body 26, so that stress occurring during elastic expansion, in particular during mounting or dismantling or demolding are homogeneously distributed in the annular body 26.

When assembling a valve unit which substantially comprises a valve, in particular a slip-in valve, a valve block 10 according to FIGS. 1 to 3 and a retaining element 25 according to FIGS. 4 to 6, the retaining element 25 is pre-positioned by sliding it onto the collar 13 of the valve block 10. During the sliding process, the collar 13 interacts with the insertion chamfer 33 of the retaining element 25 in such a manner that the latter is expanded in the circumferential direction. As a result, the through hole of the retaining element 25 becomes larger so that the collar 13 of the valve block 10 engages with the space 29. Subsequently, the valve is inserted at least partially into the cavity 11 of the valve block until the valve engages with a mating contour, in particular a mating collar, in the same way as the collar 13 of the valve block 10 engages with the space 29. In the mounted state, the valve block 10 and the valve are positively connected through the retaining element 25. The retaining element 25 holds the valve axially in and/or on the valve block 10. In other words, in the mounted state, the valve is axially fixed in and/or on the valve block 10 by the retaining element 25.

In a manufacturing method according to the invention, the retaining element 25 is formed in one piece by at least one injection molding process. By means of the injection molding process, the retaining element 25 is positively arranged on a core of an injection mold. In order to remove the retaining element 25 from the core, the retaining element 25 or the annular body 26 is elastically deformed by spreading it apart using a removal tool. In doing so, the retaining element 25 is elastically deformed until the through hole of the annular body 26 corresponds to the maximum size of an outer contour of the core. As a result of the improved structural configuration of the retaining element 25, a complex and cost-intensive collapsible core for demolding the retaining element 25 can be eliminated, as a result of which manufacturing costs can be reduced considerably.

FIG. 7 shows a schematic sectional view of the transitions 32′, 32″, 42, which are formed according to the method of tensile triangles. The transitions 32′, 32″, 42 have the longitudinal side 51 and the broad side 52. The longitudinal side 51 of the transitions 32′, 32″, 42 extends in the direction of the tensile force. The broad side 52 runs substantially transverse to the direction of tensile force.

In general, the method of tensile triangles combines several, in particular three, tensile triangles 49. The tensile triangles 49 are configured as isosceles triangles. A first tension triangle 49′ can substantially form a right-angled triangle. The two legs of a second tensile triangle 49″ correspond to the length of half the hypotenuse of the first tensile triangle 49″, wherein the hypotenuse of the second tensile triangle 49″ extends from half the length, in particular the middle, of the hypotenuse of the first tensile triangle 49″. Furthermore, the two legs of a third tensile triangle 49′″ correspond to the length of half the hypotenuse of the second tensile triangle 49″, wherein the hypotenuse of the third tensile triangle 49′″ extends from the middle of the hypotenuse of the second tensile triangle 49″. With such an arrangement of the tensile triangles 49, stress in the region of the respective transition 32′, 32″, 42 is reduced, and the service life of the retaining element 25 as well as the collar 13 of the valve block 10 is thus increased.

By means of the method of tensile triangles, the tensile stress occurring during operation and/or mounting is homogeneously distributed in the transitions 32′, 32″, 42. In other words, the tensile stress occurring locally in the transitions 32′, 32″, 42 are minimized by means of the tension triangle formation.

### REFERENCE LIST

10 valve block
11 cavity
12 openings
13 collar
14 mounting area
15 blind hole
16 sealing surface
17 first axial end of the cavity
18 contour
19 contact area
21 extension
22 ribs
23 positive-locking means
24 underside
25 retaining element
26 annular body
27 extensions
28 axial end of the annular body
29 space
31 contact surface
32 transition
33 insertion chamfer
34 receiving element
35 ribs
36 base body
37 reinforcement structure
38 through holes
39 circumferential groove
41 steps
42 transition
43 second axial end
44 conical sections
45 ring ends
46 slot
47 head side
48 inner circumferential surface
49 tensile triangles
51 longitudinal side
52 broad side

1-27. (canceled)

28. A valve block for a slip-in valve comprising:
at least one cavity for receiving the valve;
a first opening for inlet of a fluid and a second opening for outlet of the fluid, wherein the openings open into the cavity;
a mounting area in which the openings are provided; and
a collar extending at least in sections around the cavity for securing the valve, wherein the collar extends radially outwards from the cavity, wherein the collar is adapted for connecting the valve block to the valve using a retaining element, and wherein the valve block is integrally formed by injection molding or die casting.

29. The valve block according to claim 28, wherein the collar is formed at a first axial end of the cavity, and wherein the cavity is open outward for inserting the valve.

30. The valve block according to claim 28, wherein the collar connecting the valve block is formed to radially extend circumferentially around the cavity.

31. The valve block according claim 28, wherein the collar has a contact surface on a front side against which the valve rests during mounting.

32. The valve block according to claim 28, wherein at least one extension is formed radially outwards and axially spaced apart from the collar.

33. The valve block according to claim 28, further comprising a multiplicity of grid-shaped ribs.

34. The valve block according to claim 28, further comprising at least one positive-locking connection for connecting the valve block to further valve blocks in a space-saving manner.

35. The valve block according to claim 34, wherein the positive-locking connection is V-shaped or dovetail-shaped.

36. The valve block according to claim 28, wherein the mounting area is arranged on an underside of the valve block for coupling to at least one flange connection.

37. The valve block according to claim 28, wherein the mounting area is connected to the cavity through the openings for flow of the fluid.

38. A valve block comprising:
at least one cavity for receiving a valve;
a first opening for inlet of a fluid and a second opening for outlet of the fluid, wherein the openings open into the cavity;
a mounting area in which the openings are located; and
a collar extending at least in sections around the cavity for securing the valve, wherein the collar extends radially outwards from the cavity, wherein the collar is adapted for connecting the valve block to the valve using a retaining element, and wherein the valve block is integrally formed by injection molding or die casting; and wherein the retaining element includes,
an annular body formed to be open radially outwards and having a plurality of extensions which extend radially inwards, wherein the extensions are respectively arranged at axial ends of the annular body and are axially spaced apart from one another such that a space is formed between the extensions for receiving the valve or valve block, wherein the extensions have at least one contact surface formed axially on an inside, wherein the annular body has a multiplicity of ribs extending radially outwards, and wherein each of the ribs connects two axially opposed extensions for increasing a holding force.

39. The valve block according to claim 38, wherein the annular body is elastically deformable for mounting or dismantling.

40. The valve block according to claim 38, wherein each of the plurality of extensions is arranged at axial ends, and wherein the extensions are uniformly distributed in the circumferential direction.

41. The valve block according to claim 38, wherein at least one transition between the extensions and the annular body is formed according to a method of tensile triangles.

42. The valve block according to claim 38, wherein the extensions are each formed to be trapezoidal in cross-section.

43. The valve block according to claim 38, wherein the extensions have a modulus of resistance increasing from an inside radially outwards towards the annular body.

44. The valve block according to claim 38, wherein the extensions at both axial ends of the annular body each form at least one insertion chamfer for the valve and valve block which extends axially inwards.

45. The valve block according to claim 38, wherein the annular body has at least two receiving elements for elastically deforming the retaining element.

46. The valve block according to claim 38, wherein the ribs are arranged uniformly distributed in a circumferential direction so that stress occurring in the retaining element during elastic expansion is distributed homogeneously during mounting.

47. A method of manufacturing a valve block comprising:
injection molding the valve block having at least one cavity for receiving a valve and having a first opening for inlet of a fluid and a second opening for outlet of the fluid, wherein the openings open into the cavity, the valve block including a mounting area in which the openings are located, the valve block including a collar extending at least in sections around the cavity for securing the valve, wherein the collar extends radially outwards from the cavity, wherein the collar is adapted for connecting the valve block to the valve using a retaining element; and
injection molding the retaining element having an annular body formed as a single piece which is open radially outwards and has a multiplicity of extensions which extend radially inwards, the extensions each being arranged at an axial end of the annular body and being axially spaced apart from one another such that a space is formed between the extensions for receiving the valve and valve block.

48. The method of manufacturing according to claim 47, wherein the annular body is positively arranged on a core of an injection mold by an injection molding process.

49. The method of manufacturing according to claim 47, further comprising removing the annular body from the core by elastic deformation.

50. The method of manufacturing according to claim 49 further comprising elastically deforming the annular body for removal by a puller collet.
